(19) United States
(12) Patent Application Publication
(10) Pub. No.: US 2012/0232737 A1
(43) Pub. Date: Sep. 13, 2012

(54) ELECTRONIC CAR AND CONTROL METHOD THEREOF

(75) Inventor: Byoung Sun Jeon, Anyang-si (KR)

(73) Assignee: V-ENS Co., Ltd., Incheon (KR)

(21) Appl. No.: 13/505,425

(22) PCT Filed: Nov. 1, 2010
(86) PCT No.: PCT/KR2010/007580

§ 371 Date: May 29, 2012

(30) Foreign Application Priority Data
Nov. 3, 2009 (KR) 10-2009-0105599

(51) Int. Cl. B60L 15/20

(52) U.S. Cl. 701/22

(57) ABSTRACT

The present invention relates to an electronic car and a method of controlling same. More specifically, the present system enters a non-slip mode when a vehicle is on an incline and the brakes are applied making the vehicle come to a stop. When a preset brake sensor value is met, an anti-slip torque value is calculated and when the vehicle begins to move again on the incline, the calculated torque value is applied from the engine in the direction opposite to the slip as the operator moves from the brake pedal to the accelerator pedal. In this way, slippage is prevented during the duration of the switch in pedals.

### TECHNICAL FIELD

The present invention relates to an electric vehicle and a control method thereof, and more particularly, to an electric vehicle capable of preventing vehicle slip when starting from a stop on an incline, and a control method thereof.

### BACKGROUND ART

Electric vehicles have been actively studied because they are the most promising alternative capable of solving pollution and energy problems in the future.

Electric vehicles (EV) are mainly powered by driving an AC or DC motor using power of a battery. The electric vehicles are broadly classified into battery powered electric vehicles and hybrid electric vehicles. In the battery powered electric vehicles, a motor is driven using power of a battery, and the battery is rechargeable after the stored power is completely consumed. In the hybrid electric vehicles, a battery is charged with electricity generated via engine driving, and an electric motor is driven using the electricity to realize vehicle movement.

The hybrid electric vehicles may further be classified into serial type ones and parallel type ones. In the case of serial hybrid electric vehicles, mechanical energy output from an engine is changed into electric energy via a generator, and the electric energy is fed to a battery or motor. Thus, the serial hybrid electric vehicles are always driven by a motor similar to conventional electric vehicles, but an engine and generator are added for the purpose of increasing a traveling range. Parallel hybrid electric vehicles may be driven using two power sources, i.e. a battery and an engine (gasoline or diesel). Also, the parallel hybrid electric vehicles may be driven using both the engine and the motor according to traveling conditions.

With recent gradual development of motor/control technologies, small high-output and high-efficiency systems have been developed. Owing to replacing a DC motor by an AC motor, electric vehicles have accomplished considerably enhanced output and power performance (acceleration performance and maximum speed) comparable to those of gasoline vehicles. As a result of promoting a higher output and higher revolutions per minute, a motor has achieved reduction in weight and size, and consequently reduction in the weight and size of a vehicle provided with the motor.

Meanwhile, under a situation in which a vehicle temporarily stops and then, is started on an incline, a vehicle may slip backward in case of switching from a brake pedal to an accelerator pedal. Therefore, it is necessary to prevent such vehicle slip via torque control.

### DISCLOSURE

### Technical Problem

Therefore, the present invention has been made in view of the above problems, and it is an object of the present invention to provide an electric vehicle and a control method thereof, which can prevent vehicle slip by applying a motor torque in an opposite direction of a vehicle slip direction, in case of switching from a brake pedal to an accelerator pedal for starting from a stop on an incline.

### Technical Solution

In accordance with one aspect of the present invention, the above and other objects can be accomplished by the provision of a control method of an electric vehicle including entering an anti-slip mode if a stopped of the electric vehicle is maintained for a preset time or more when the electric vehicle stops by braking on an incline, calculating an anti-slip torque to apply drive force in an opposite direction of a vehicle slip direction if a brake sensor value is a predetermined value or less in the anti-slip mode, and applying the anti-slip torque to a motor to prevent vehicle slip.

The control method may further include comparing a traveling torque, calculated based on an accelerator sensor value, with the anti-slip torque if the accelerator sensor value is sensed in the anti-slip mode, and releasing the anti-slip mode if the traveling torque is greater than the anti-slip torque.

The control method may further include comparing the anti-slip torque with a preset value, and releasing the anti-slip mode if the anti-slip torque is greater than the preset value.

The control method may further include increasing or decreasing the anti-slip torque based on a wheel sensor value in a state in which the anti-slip torque is applied to the motor.

In accordance with another aspect of the present invention, there is provided an electric vehicle including an incline angle sensor to sense the angle of an incline, a brake sensor to sense an operating degree of a brake pedal, a motor to enable vehicle traveling via rotation thereof, and a control unit that judges whether or not the vehicle is on an incline using an incline angle sensor, enters an anti-slip mode if the vehicle is maintained in a stopped state for a predetermined time or more on the incline, calculates an anti-slip torque to apply drive force in an opposite direction of a vehicle slip direction if a brake sensor value is a predetermined value or less, and applies the anti-slip torque to the motor.

### Advantageous Effects

In an electric vehicle and a control method thereof according to the present invention, when the electric vehicle is started from a stopped state on an incline, it is possible to prevent vehicle slip in case of switching from a brake pedal to an accelerator pedal, as a result of applying a motor torque in an opposite direction of a vehicle slip direction.

Further, according to the present invention, owing to omission of an unnecessary parking pawl, it is possible to minimize damage to the internal structure of the electric vehicle due to the parking pawl, and to achieve comfortable traveling and ride when starting the electric vehicle from a stopped state.

### DESCRIPTION OF DRAWINGS

FIG. 1 is a diagram schematically illustrating an internal configuration of an electric vehicle according to an embodiment of the present invention;

FIG. 2 is a diagram illustrating a configuration for calculating an anti-slip torque according to an embodiment of the present invention;

FIG. 3 is a view illustrating a vehicle located on an incline according to an embodiment of the present invention; and

FIG. 4 is a flowchart illustrating a control method of the electric vehicle according to an embodiment of the present invention.

### BEST MODE

Hereinafter, the exemplary embodiment of the present invention will be described with reference to the accompanying drawings.

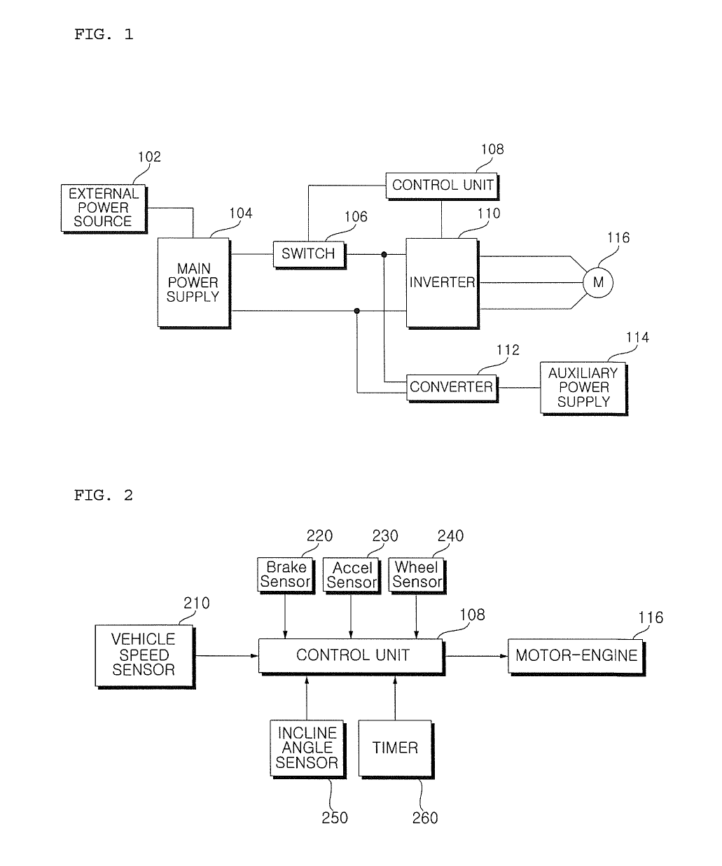

FIG. 1 is a diagram schematically illustrating an internal configuration of an electric vehicle according to an embodiment of the present invention.

Referring to FIG. 1, the electric vehicle according to the present invention includes a main power supply 104, which is charged upon receiving power from an external power source 102 and supplies the received power to loads, such as a motor 116 and other electric elements, and an on/off switch 106 to control power transmission from the main power supply 104 to an inverter 110 based on operating signals of a control unit 108. The control unit 108 controls a switching operation of the inverter 110, and also controls the on/off switch 106 in response to user input signals. The inverter 110 converts DC power of the main power supply 104 into AC power, to supply the power of the main power supply 104 to the motor 116 that is connected to a drive unit (not shown). The electric vehicle further includes a converter 112, which is connected in parallel to the inverter 110 and performs DC/DC conversion to covert the power supplied from the main power supply 104 into high-voltage and constant-current power when the on/off switch 106 is switched on, and an auxiliary power supply 114, which accumulates the power supplied from the converter 112 and supplies the power to the electric elements within the vehicle, such as a room lamp, a turn signal, a radio, and the like.

The control unit 108 enters an anti-slip mode when the vehicle stops by braking on an incline and is maintained in a stopped state for a preset time. If a brake sensor value fulfills a preset condition in the anti-slip mode, the control unit 108 calculates an anti-slip torque and applies the calculated torque to the motor.

In this case, the control unit 108 may judge the incline based on the angle of the incline sensed by an incline angle sensor.

Here, the preset condition is a condition in that the brake sensor value becomes a predetermined value or less, and corresponds to a time when a driver, who has pushed a brake pedal to stop the vehicle, takes their foot off the brake pedal to push an accelerator pedal when starting the vehicle from a stopped state. The control unit judges that the preset condition is fulfilled if the driver takes their foot off the brake pedal to a predetermined degree.

That is, if a sensor value sensed by the brake sensor becomes a predetermined value or less at the time when the driver takes their foot off the brake pedal, the control unit 108 judges that the preset condition is fulfilled, and then calculates the anti-slip torque to apply the anti-slip torque to the motor.

The control unit 108 calculates the anti-slip torque in order to apply drive force in an opposite direction of a vehicle slip direction. In this case, assuming that the angle of the incline sensed by the incline angle sensor is θ, the anti-slip torque may be calculated in proportion to sin θ. Also, the anti-slip torque may be calculated in proportion to the weight of the vehicle, or may be calculated in proportion to preset weighted propelling force.

If a traveling torque is sensed based on an accelerator sensor value in a state in which the control unit 108 enters the anti-slip mode and applies the calculated anti-slip torque to the motor, the control unit 108 compares the traveling torque with the anti-slip torque, and releases the anti-slip mode if the traveling torque is greater than the anti-slip torque. In this way, vehicle traveling is conducted.

As described above, if the brake sensor value fulfills the preset condition in a state in which the control unit 108 enters the anti-slip mode on the incline, the control unit 108 calculates the anti-slip torque to apply the anti-slip torque to the motor, and compares the calculated anti-slip torque with a preset value. If the anti-slip torque is greater than the preset value, the control unit 108 may release the anti-slip mode.

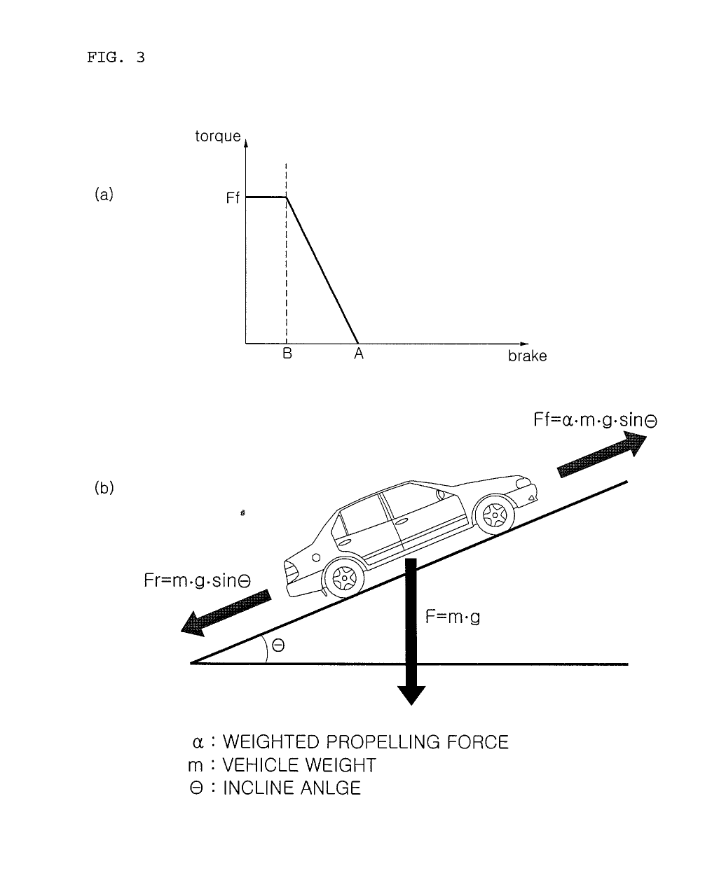

FIG. 2 is a diagram illustrating a configuration for calculating the anti-slip torque according to an embodiment of the present invention, and FIG. 3 is a view illustrating the vehicle located on the incline according to an embodiment of the present invention.

As illustrated in FIG. 2, in addition to the configuration of FIG. 1, the electric vehicle includes a vehicle speed sensor 210, a brake sensor 220, an accelerator sensor 230, a wheel sensor 240, an incline angle sensor 250, and a timer 260.

The control unit 108 of the electric vehicle judges whether or not the vehicle is on the incline based on the angle of the incline sensed by the incline angle sensor 250. In particular, when the vehicle stops, the control unit 108 judges whether or not the vehicle is on the incline based on a measured value of the incline angle sensor.

Accordingly, the control unit 108 can enter the anti-slip mode in the case in which the vehicle stops by braking on the incline and is maintained in a stopped state for a preset time.

In this case, the control unit 108 judges whether or not the vehicle stops using the vehicle speed sensor 210, and measures a stopped time using the timer 260.

If the sensor value sensed by the brake sensor 220 is a predetermined value or less to fulfill the preset condition, the control unit 108 calculates the anti-slip torque to apply the anti-slip torque to the motor 116. If the sensor value of the brake sensor 220 is within a section A-B shown in FIG. 3(a), the control unit 108 judges that the sensor value fulfills the preset condition, thereby applying the anti-slip torque to the motor.

In this case, if the driver takes their foot off the brake pedal to a predetermined degree, the control unit compares the value measured by the brake sensor 220 with a reference value. The reference value may be changed according to an anti-slip degree. For example, under the condition of a steep incline, the anti-slip torque may be calculated even if the driver takes their foot off the brake pedal very slightly.

That is, when starting from a stop, the driver should take their foot off the brake pedal to push the accelerator pedal so as to start and accelerate the vehicle. The control unit enters the anti-slip mode after a predetermined time has passed after the vehicle stops. Then, as the driver takes their foot off the brake pedal and pushes the accelerator pedal for starting the vehicle from a stopped state, the control unit applies the anti-slip torque to the motor 116 based on the sensor value sensed by the brake sensor if the driver takes their foot off the brake pedal to a predetermined degree, thereby preventing vehicle slip.

The control unit 108, as shown in FIG. 3(b), calculates the anti-slip torque to apply drive force in an opposite direction of a vehicle slip direction. Assuming that the angle of the incline sensed by the incline angle sensor 230 is θ, the anti-slip torque may be calculated in proportion to sin θ. Also, the anti-slip torque may be calculated in proportion to the weight of the vehicle, or may be calculated in proportion to preset weighted propelling force.

That is, an anti-slip drive force Ff may be applied in an opposite direction of a vehicle slip force Fr on the incline. The vehicle slip force Fr may be calculated by the following Equation:

Ff=α mg sin θ

Here, “α” is preset weighted propelling force, “m” is the weight of the vehicle, and “θ” is the angle of the incline sensed by the incline angle sensor.

If a traveling torque is applied based on a sensor value sensed by the accelerator sensor 230, the control unit 108 compares the applied traveling torque with the calculated anti-slip torque. If the traveling torque is greater than the anti-slip torque, the control unit may release the anti-slip mode.

That is, when the driver pushes the accelerator pedal for starting the vehicle from a stopped state, the pedal force is measured by the accelerator sensor and is applied to the control unit 108. As the control unit 108 releases the anti-slip mode by calculating the traveling torque according to the accelerator sensor value, vehicle traveling is conducted.

Also, the control unit 108 may increase or decrease the anti-slip torque based on the sensor value sensed by the wheel sensor 240 that senses a minute rotation of a wheel.

For example, since the vehicle traveling may be affected by the number of passengers and road conditions as well as the angle of the incline, the control unit 108 may increase the anti-slip torque based on the wheel sensor value. That is, if wheel rotation occurs under the condition of the steep incline, the control unit may increase or decrease the anti-slip torque based on the wheel rotation.

More specifically, the anti-slip torque is calculated in proportion to the angle of the incline. While the anti-slip torque is applied to the motor 116 to prevent vehicle slip, if the sensor value of the wheel sensor 240 reaches a predetermined value or more, the control unit judges that anti-slip is not available for the above described reasons, and thus changes the anti-slip torque.

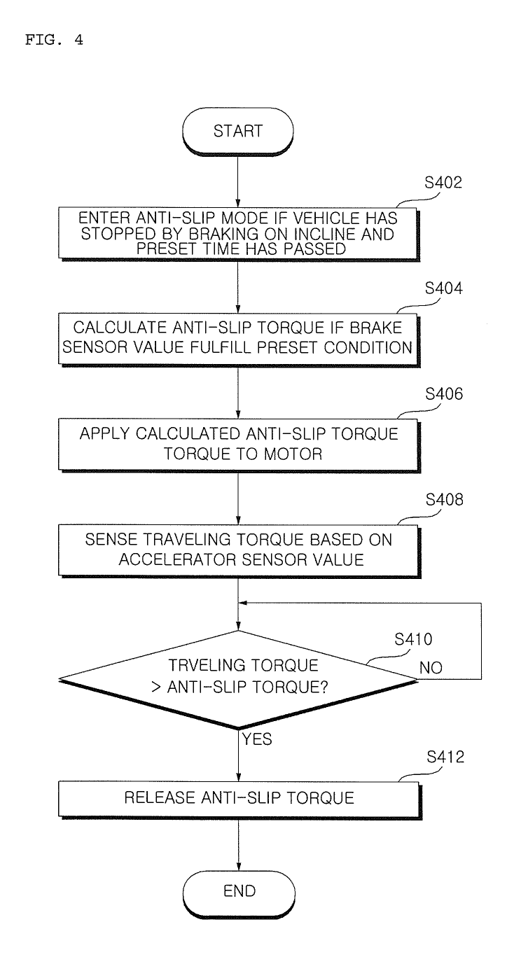

FIG. 4 is a flowchart illustrating a control method of the electric vehicle according to an embodiment of the present invention.

Referring to the drawing, if the vehicle stops by braking on the incline and is maintained in a stopped state for a preset time, that is, after the preset time has passed, the control unit of the electric vehicle may enter the anti-slip mode (S402). In this case, the control unit of the electric vehicle may judge whether or not the vehicle is on the incline based on the angle of the incline sensed by the incline angle sensor.

If the sensor value sensed by the brake sensor fulfills the preset condition, the control unit of the electric vehicle may calculate the anti-slip torque (S404), and may apply the anti-slip torque to the motor (S406). In this case, the preset condition may correspond to the condition in which brake pedal force is a predetermined value or less.

Here, the control unit of the electric vehicle calculates the anti-slip torque to apply drive force in an opposite direction of a vehicle slip direction. Assuming that the angle of the incline sensed by the incline angle sensor is θ, the anti-slip torque may be calculated in proportion to sin θ. Also, the anti-slip torque may be calculated in proportion to the weight of the vehicle, or may be calculated in proportion to preset weighted propelling force.

Also, if the accelerator sensor senses the traveling torque (S408), the control unit of the electric vehicle compares the sensed traveling torque with the calculated anti-slip torque (S410).

If it is determined based on the comparative result that the traveling torque is greater than the anti-slip torque, the control unit of the electric vehicle releases the anti-slip mode (S412), and may enter a normal traveling mode.

In this way, in case of starting the vehicle after a stop on the incline, it is possible to prevent vehicle slip by applying a motor torque in an opposite direction of a vehicle slip direction in case of switching from the brake pedal to the accelerator pedal.

Although the embodiment of the present invention has been disclosed for illustrative purposes, those skilled in the art will appreciate that various modifications, additions and substitutions are possible, without departing from the scope and spirit of the invention as disclosed in the accompanying claims.

1. A control method of an electric vehicle, comprising:
entering an anti-slip mode if a stopped state of the electric vehicle is maintained for a preset time or more when electric vehicle stops by braking on an incline;
calculating an anti-slip torque to apply drive force in an opposite direction of a vehicle slip direction if a brake sensor value is a predetermined value or less in the anti-slip mode; and
applying the anti-slip torque to a motor to prevent vehicle slip.

2. The control method according to claim 1, further comprising:
comparing a traveling torque, calculated based on an accelerator sensor value, with the anti-slip torque if the accelerator sensor value is sensed in the anti-slip mode; and
releasing the anti-slip mode if the traveling torque is greater than the anti-slip torque.

3. The control method according to claim 1, further comprising:
comparing the anti-slip torque with a preset value; and
releasing the anti-slip mode if the anti-slip torque is greater than the preset value.

4. The control method according to claim 1, further comprising judging whether or not the vehicle is on the incline based on the angle of the incline sensed by an incline angle sensor when the vehicle stops.

5. The control method according to claim 1, further comprising increasing or decreasing the anti-slip torque based on a wheel sensor value in a state in which the anti-slip torque is applied to the motor.

6. The control method according to claim 1, wherein the brake sensor value is a value sensed based on the pushed degree of a brake pedal and the released degree of the brake pedal.

7. The control method according to claim 1, wherein the anti-slip torque is calculated in proportion to sine under the assumption that the angle of the incline sensed by the incline angle sensor is θ.

8. The control method according to claim 1, wherein the anti-slip torque is calculated in proportion to the weight of the vehicle.

9. The control method according to claim 1, wherein the anti-slip torque is calculated in proportion to preset weighted propelling force.

10. The control method according to claim 1, wherein a calculated value of the anti-slip torque is increased or decreased based on a sensor value sensed by a wheel sensor that senses wheel rotation.

11. An electric vehicle comprising:
an incline angle sensor to sense the angle of an incline;
a brake sensor to sense an operating degree of a brake pedal;
a motor to enable vehicle traveling via rotation thereof; and
a control unit that judges whether or not the vehicle is on an incline using an incline angle sensor, enters an anti-slip mode if the vehicle is maintained in a stopped state for a predetermined time or more on the incline, calculates an anti-slip torque to apply drive force in an opposite direction of a vehicle slip direction if a brake sensor value is a predetermined value or less, and applies the anti-slip torque to the motor.

12. The electric vehicle according to claim 11, wherein the control unit calculates the anti-slip torque via the following Equation and applies the anti-slip torque to the motor:
Ef==α mg sin θ
(Here, “α” is preset weighted propelling force, “m” is the weight of the vehicle, and “θ” is the angle of the incline sensed by the incline angle sensor).

13. The electric vehicle according to claim 11, further comprising an accelerator sensor to sense an operating degree of an accelerator pedal,
wherein, if an accelerator sensor value is sensed in the anti-slip mode, the control unit releases the anti-slip mode to initiate vehicle traveling if a traveling torque calculated by the accelerator sensor value is greater than the anti-slip torque.

14. The electric vehicle according to claim 11, further comprising a wheel sensor to sense wheel rotation,
wherein the control unit increases or decreases the antis-slip torque based on a wheel sensor value in a state in which the anti-slip torque is applied to the motor.
